(19) United States
(12) Patent Application Publication
(10) Pub. No.: US 2024/0190215 A1
(43) Pub. Date: Jun. 13, 2024

(54) FLUID HEATER

(71) Applicant: Hanon Systems, Daejeon (KR)

(72) Inventors: Jun Su Kim, Daejeon (KR); Jae Won Lee, Daejeon (KR)

(21) Appl. No.: 18/568,920

(22) PCT Filed: Dec. 29, 2022
(86) PCT No.: PCT/KR2022/021599

§ 371 Date: Dec. 11, 2023

(30) Foreign Application Priority Data
Jan. 4, 2022 (KR) 10-2022-0000853

(51) Int. Cl. B60H 1/22

(52) U.S. Cl. CPC B60H 1/2221; B60H 2001/2278

(57) ABSTRACT

Vehicle air conditioning apparatus comprising air conditioning case with inlet and outlet, partition wall dividing the inner space into a first and a second space portions; cooling heat exchanger disposed inside the air conditioning case to span the first and second space portions and connected to the outlet; and heat exchanger disposed inside the air conditioning case to span the first and second space portions. The air conditioning case includes a first flow path disposed in the second space portion below the heat exchanger; a channel part disposed behind the heat exchanger, with its entrance communicating with the first flow path, and exit communicating with the first space portion. Accordingly, a portion of air flowing to the first flow path via cooling heat exchanger without passing through heat exchanger is guided to the first space portion via the channel part without being mixed with air passing through heating heat exchanger.

### TECHNICAL FIELD

Embodiments relate to a fluid heater. More particularly, embodiments relate to a fluid heater in which a controller and a heating module are detachable.

### BACKGROUND ART

Most common vehicles today use an engine as their power sources. Engines use gasoline, diesel and so on as energy sources, which have various problems such as environmental pollution and dwindling oil reserves. As a result, the need for new energy sources is gradually increasing, and vehicles that use new energy sources, such as electric vehicles, are being developed or are in the process of commercialization.

However, electric vehicles do not have a heat source that generates a lot of heat, such as an engine, so it is necessary to install an additional heat source for use in the vehicle's air conditioning system.

Heat sources that are additionally installed in conventional electric vehicles include heat pumps and electric heaters, and among them, the electric heaters are widely used because they can be applied without significantly changing the design of existing air conditioning system. Here, the electric heaters are generally divided into air-heated heaters, which directly heat the air blown into the vehicle cabin, and fluid-heated heaters (or coolant heaters), which indirectly heat the air by heating the coolant that exchanges heat with the air. And, related inventions include Korea Patent Publication No. 10-2018-0005410 (Jan. 16, 2018, Cooling-Water Heater).

### DISCLOSURE

### Technical Problem

The purpose of the embodiments is to reduce repair costs by allowing a controller module and a heating module to be detached.

The purpose of the embodiments is to suppress the deformation that occurs in a heating module.

Objectives to be solved by the present invention are not limited to the above-described objectives, and other objectives, which are not described above, will be clearly understood by those skilled in the art from the following description.

### Technical Solution

An embodiment of the present invention may be characterized in that it includes: a main body having a plate-like compartment, and a heating plate having a flow path arranged at a lower portion thereof; a controller module including a controller body and a substrate disposed within the controller body, the controller module being disposed on an upper portion of the main body; a lower cover disposed on a lower portion of the main body; and an upper cover disposed an upper portion of the controller module, wherein the main body and the controller module are detachably coupled.

Preferably, the embodiment may be characterized in that the substrate is spaced apart from a bottom surface of the controller body.

Preferably, the embodiment may be characterized in that the heating plate and the substrate are connected by a busbar.

Preferably, the embodiment may be characterized in that a first gasket is disposed between the main body and the controller body.

Preferably, the embodiment may be characterized in that the flow path is formed by the heating plate and the compartment.

Preferably, the embodiment may be characterized in that the flow path includes a plurality of straight portions and curved portions.

Preferably, the embodiment may be characterized in that the straight portions are divided by a plurality of partition walls.

Preferably, the embodiment may be characterized in that a plurality of radiating fins are disposed in an area of the straight portions.

Preferably, the embodiment may be characterized in that a heating layer is disposed on a bottom surface of the heating plate on which the flow path is formed.

Preferably, the embodiment may be characterized in that a second gasket is disposed between the heating plate and the compartment.

Preferably, the embodiment may be characterized in that the second gasket is disposed along an outer wall of the flow path.

### Advantageous Effects

According to the embodiments, if the heater needs to be replaced due to a failure, only the failed parts in the controller module and the heating module are repaired, thereby facilitating the repair and reducing repair costs.

Further, the embodiments have the effect of preventing deformation of the heating module.

Various advantages and effects of the present invention are not limited to the above description, and may be more easily understood in the process of describing specific embodiments of the present invention.

### BRIEF DESCRIPTION OF THE DRAWINGS

FIG. 1 is a perspective view of a fluid heater according to an embodiment of the present invention.

FIG. 2 is an internal cross-sectional view of FIG. 1.

FIG. 3 are exploded perspective view of FIG. 1.

FIG. 4 is a view showing a bottom surface of a main body, which is a component of FIG. 1.

FIG. 5 a perspective view of a heating module, which is a component of FIG. 1.

FIG. 6 a view showing an top surface of FIG. 5.

FIG. 7 a view showing a bottom surface of FIG. 5.

FIG. 8 is a diagram showing a force applied to a heating module, which is a component of FIG. 1.

### BEST MODE

Hereinafter, preferred embodiments of the present invention will be described in detail with reference to the accompanying drawings.

However, the technical idea of the present invention is not limited to some embodiments described, but may be implemented in various forms, and within the scope of the technical idea of the present invention, one or more of the components may be selectively combined and substituted between the embodiments.

In addition, terms (including technical and scientific terms) used in the embodiments of the present invention, unless expressly specifically defined and described, may be construed to have a meaning that would be generally understood by a person of ordinary skill in the art to which the present invention belongs, and commonly used terms, such as dictionary-defined terms, may be interpreted in light of their contextual meaning in the relevant art.

Further, the terms used in the embodiments of the present invention are intended to describe the embodiments and are not intended to limit the present invention.

In this specification, the singular form may include the plural form unless specifically stated in the sentence, and references to “at least one (or one or more) of A and (or) B, and C” may include one or more of any combination of A, B, and C that may be combined.

Further, in describing components of the embodiments of the present invention, the terms first, second, A, B, (a), (b), and the like may be used.

Such terms are intended only to distinguish one component from another and are not intended to limit by the terms the nature, sequence, or order of such components.

In addition, when a component is described as being “connected,” “coupled,” or “attached” to another component, it may mean not only that the component is directly connected, coupled, or attached to the other component, but also that the component is “connected,” “coupled,” or “attached” by virtue of another component located between the component and another component.

In addition, when a component is described as being formed or disposed “on(above)” or “under(below)” another component, “on(above)” or “under(below)” includes not only when two components are in direct contact with each other, but also when one or more other components are formed or disposed between the two components. Also, when expressed as “up (above)” or “down (below)”, it may include the meaning of not only the upward direction but also the downward direction with respect to a single component.

Hereinafter, the embodiments will be described in detail with reference to the accompanying drawings, wherein identical or corresponding components will be assigned the same reference numerals regardless of drawing designation, and duplicate descriptions will be omitted.

FIGS. 1 to 8 clearly illustrate only the main features of the present invention in order to provide a conceptual understanding of the invention, and as a result, various variations of the illustrations are anticipated, and the scope of the present invention need not be limited by the specific geometry shown in the drawings.

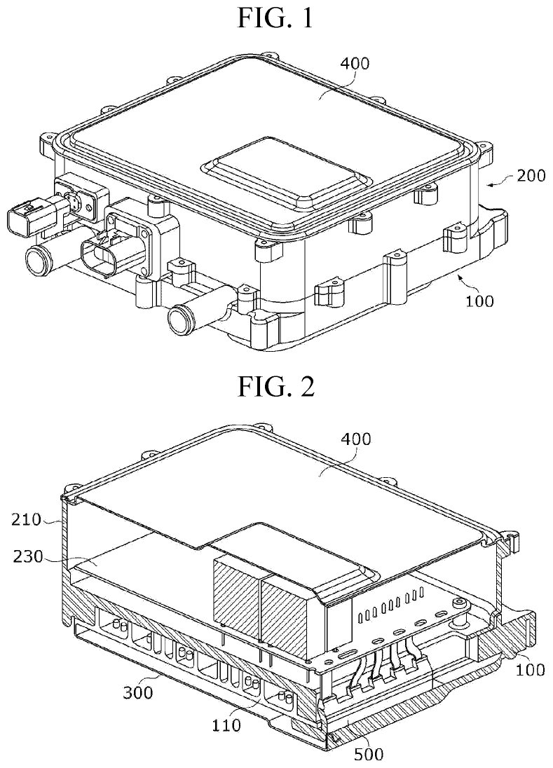

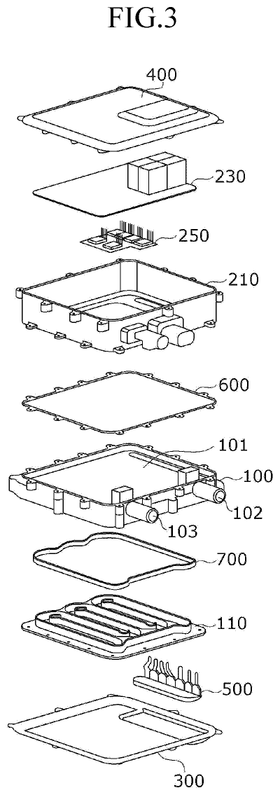

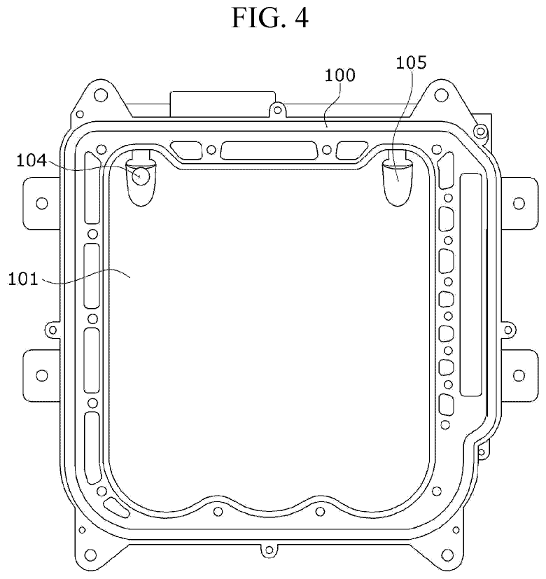

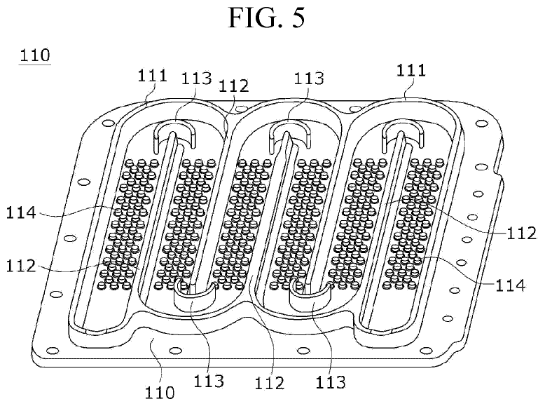

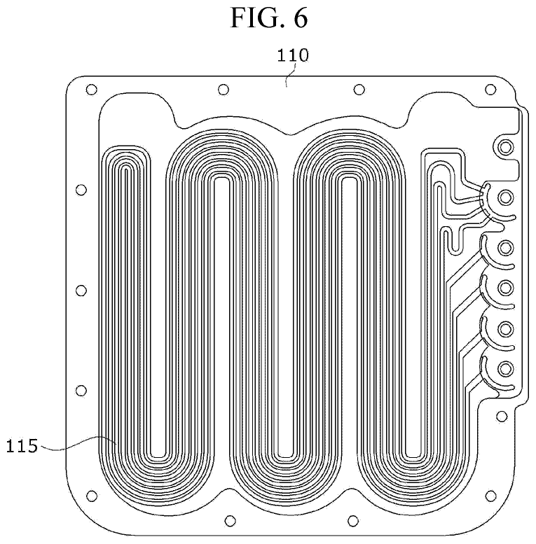

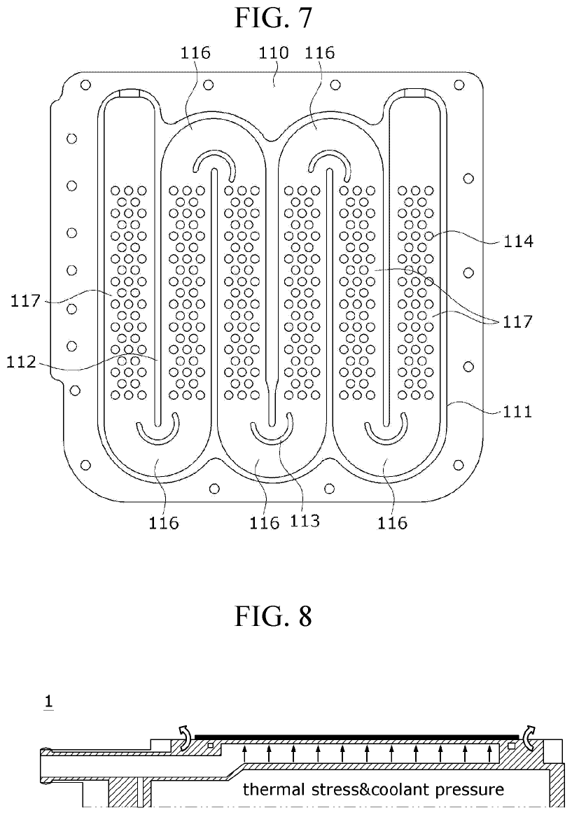

FIG. 1 is a perspective view of a fluid heater according to an embodiment of the present invention; FIG. 2 is an internal cross-sectional view of FIG. 1; FIG. 3 are exploded perspective view of FIG. 1; FIG. 4 is a view showing a bottom surface of a main body, which is a component of FIG. 1; FIG. 5 a perspective view of a heating module, which is a component of FIG. 1; FIG. 6 a view showing an top surface of FIG. 5; FIG. 7 a view showing a bottom surface of FIG. 5; and FIG. 8 is a diagram showing a force applied to a heating module, which is a component of FIG. 1.

Referring to FIGS. 1 to 8, a fluid heater 1 according to an embodiment of the present invention may include a main body 100, a controller module 200, a lower cover 300, and an upper cover 400.

The present invention may have a structure in which the main body 100, in which a heating plate 110 is disposed, and the controller module 200 are detachable. By making the main body 100 in which the heating plate 110 is disposed and the controller module 200 in which a substrate 230 is provided detachable, only the failed part of the controller module 200 and the main body 100 may be replaced when replaced due to a failure of the fluid heater 1, thereby solving the problem of replacing the whole when the fluid heater 1 fails.

The main body 100 may have a plate-like compartment 101, and the heating plate 110 having a flow path formed thereon may be disposed at the lower portion of the main body.

The main body 100 may include a fluid supply pipe 102 and a fluid outlet pipe 103 coupled to it. The fluid supply pipe 102 may act as a passage through which fluid flows into the flow path, and the fluid outlet pipe 103 may act as a passage through which fluid flows out of the flow path.

The fluid supply pipe 102 may be connected with an inlet 105 disposed on one side of the compartment 101 for supplying fluid to the flow path, and the fluid outlet pipe 103 may be connected to an outlet 104 for discharging fluid that has passed through the flow path.

The plate-like compartment 101 formed on the main body 100 may be combined with the heating plate 110 to form the flow path. The compartment 101 may be arranged as a flat plate structure.

The flow path may be formed on one side of the heating plate 110 by its engagement with the compartment 101, and a heating layer 115 may be formed on the other side.

The flow path may be formed by the outer wall 111 and the partition wall 112, and may include a plurality of straight portions 117 and curved portions 116. The straight portions 117 and the curved portions 116 may be arranged alternately in the flow path, and a plurality of partition walls 112 may be arranged in the outer wall 111 to provide a divided structure.

The outer wall 111 may be arranged to enclose the entire flow path, and the plurality of partition walls 112 may be arranged in the inner area of the outer wall 111 to form the flow path with the curved portions 116 and the straight portions 117.

In general, the purpose of reinforcement structures in the heating plate 110 is to make the heating plate 110 less warped, and the purpose of the walls for flow path is to form the flow path and improve heat transfer between the heating plate 110 and the coolant.

There is a limitation in designing ribs simply with a reinforcement structure on the heating plate 110. First of all, a rib of the simple reinforcement structure can interfere with the coolant flow, and providing sufficient structural reinforcement can be cost prohibitive.

To avoid these problems, the partition walls 112 may guide the flow of the fluid to form a flow path, while minimizing the thermal deformation that occurs during the sintering process that is the manufacturing process of the heating plate 110.

The partition walls 112 may serve as ribs to minimize product deformation and reduce the risk of coolant leakage. This allows the heat generated by the heating element to be efficiently transferred to the flow path of the coolant.

Referring to FIG. 8, there are two forces acting on the heating plate 110. It is the pressure of the coolant on the heating plate 110 as it flows and the thermal stress generated by the heating layer 115 as it generates heat. Due to these forces, there is a concern that the heating plate 110 may be bent. However, in the present invention, structural robustness may be ensured by the outer wall 111 and the partition walls 112, which serve as ribs on the heating plate 110.

A plurality of radiating fins 114 may be disposed in the region of the straight portions 117 of the flow path. The radiating fins 114 may have various shapes and arrangements to increase the flow contact area of the fluid moving through the flow path.

Additionally, a turning vane 113 may be disposed in one area of the curved portions 116 of the flow path.

The turning vane 113 may be disposed in the space between the partition walls 112, which are disposed to face the outer wall 111 forming the curved portions 116, that is, on the front of the curved portions 116.

The turning vane 113 may be disposed adjacent to the end of the straight portions 117, and may prevent coolant flowing into the curved portions 116 from deflecting the entire flow toward the wall surface. Specifically, the turning vane 113 may be spaced apart at predetermined interval from the end of the partition wall 112 forming the straight portion 117, and may prevent the flow of coolant from being biased toward the outer wall 111 forming the curved portion 116.

The turning vane 113 may be formed such that the length of the outlet side is longer than the length of the inlet side with respect to the centerline.

The shape of the radiating fins 114 is not necessarily limited to the shape and may be deformed into various shapes.

The radiating fins 114 may transfer heat generated by the heating element to the coolant to increase cooling efficiency. In this case, the height of the radiating fins 114 may be determined within a range that minimizes the pressure drop. In one embodiment, the height of the radiating fins 114 may be determined to be in the range of 20˜50% of the height of the overall flow path.

The heating layer 115 may be disposed on the bottom surface of the heating plate 110 where the flow path is formed.

The heating layer 115 may be supplied with electricity via the busbar 500, and may be disposed along the geometry of the flow path. The type of the heating layer 115 is not limited, and various known techniques may be used. Here, the busbar 500 may be formed with a plurality of terminals.

The controller module 200 may include a controller body 210 and a substrate 230, and may be disposed on the upper portion of the main body 100.

The controller body 210 may have an internal space capable of accommodating the substrate 230. The controller body 210 may have an outer wall and a bottom surface to form an interior space, in which the substrate 230 may be seated.

The substrate 230 may be disposed on the interior of the controller body 210. In addition, the substrate 230 may be coupled to a plurality of posts projecting from on one surface of the compartment 101 by fastening members such as bolts. This allows the substrate 230 to be disposed spaced apart from the compartment 101, and provides a space between the substrate 230 and the compartment 101 in which electronic devices 250, such as transistors, may be disposed.

The substrate 230 may be connected to the heating plate 110 via the busbar 500. The busbar 500 may be connected to one side of the heating plate 110 and connected to the substrate 230 through a side surface of the main body.

In the present invention, a first gasket 600 may be disposed between the main body 100 and the controller body 210. The first gasket 600 may be disposed along the outer perimeter of the main body and, when engaged, may prevent fluid or moisture from entering the substrate 230 or electronic devices.

Additionally, a second gasket 700 may be disposed between the heating plate 110 and the compartment 101.

The second gasket 700 may be disposed along the outer wall 111 of the flow path to increase the water tightness of the flow path.

The lower cover 300 may be disposed on a lower portion of the main body 100 to close an interior space formed by the main body 100.

The upper cover 400 may be disposed on an upper portion of the controller module 200. The upper cover 400 may be connected to the upper portion of the controller body 210 to close the interior space of the controller body 210.

As mentioned above, the embodiments of the present invention have been specifically discussed in detail with reference to the accompanying drawings.

The above description is merely an exemplary description of the technical ideas of the present invention, and various modifications, changes, and substitutions will be apparent to one of ordinary skill in the art to which the present invention belongs without departing from the essential features of the invention. Accordingly, the embodiments and accompanying drawings disclosed herein are intended to illustrate and not to limit the technical ideas of the present invention, and the scope of the technical ideas of the present invention is not limited by these embodiments and accompanying drawings. The scope of protection of this invention shall be construed in accordance with the following claims, and all technical ideas within the scope of the equivalents shall be construed to be included in the scope of this invention.

### EXPLANATION OF REFERENCE NUMERALS

1: fluid heater, 100: main body, 101: compartment, 102: fluid supply pipe, 103: fluid outlet pipe, 104: Outlet, 105: inlet, 110: heating plate, 111: outer wall, 112: compartment, 113: turning vane, 114: radiating fin, 115: heating layer, 116: curved portion, 117: straight portion, 200: controller module, 210: controller body, 230: substrate, 250: electronic device, 300: lower cover, 400: upper cover, 500: busbar, 600: first gasket, 700: second gasket

What is claimed is:

1. A fluid heater comprising:
a main body having a plate-like compartment, and a heating plate having a flow path arranged at a lower portion thereof;
a controller module including a controller body and a substrate disposed within the controller body, the controller module being disposed on an upper portion of the main body;
a lower cover disposed on a lower portion of the main body; and
an upper cover disposed an upper portion of the controller module,
wherein the main body and the controller module are detachably coupled.

2. The fluid heater according to claim 1, characterized in that the substrate is spaced apart from a bottom surface of the controller body.

3. The fluid heater according to claim 2, characterized in that the heating plate and the substrate are connected by a busbar.

4. The fluid heater according to claim 1, characterized in that a first gasket is disposed between the main body and the controller body.

5. The fluid heater according to claim 1, characterized in that the flow path is formed by the heating plate and the compartment.

6. The fluid heater according to claim 1, characterized in that the flow path includes a plurality of straight portions and curved portions.

7. The fluid heater according to claim 6, characterized in that the straight portions are divided by a plurality of partition walls.

8. The fluid heater according to claim 7, characterized in that a plurality of radiating fins are disposed in an area of the straight portions.

9. The fluid heater according to claim 8, the height of the radiating fins is formed to be in the range of 20 to 50% of the overall flow path.

10. The fluid heater according to claim 7, characterized in that a heating layer is disposed on a bottom surface of the heating plate on which the flow path is formed.

11. The fluid heater according to claim 5, characterized in that a second gasket is disposed between the heating plate and the compartment.

12. The fluid heater according to claim 11, characterized in that the second gasket is disposed along an outer wall of the flow path.

13. The fluid heater according to claim 6, characterized in that the heating plate includes a turning vane disposed in one area of the curved portions.

14. The fluid heater according to claim 13, the turning vane is configured to prevent the flow of coolant introduced into the curved portions from being deflected toward the wall surface.
